(19) United States
(12) Patent Application Publication
(10) Pub. No.: US 2014/0156202 A1
(43) Pub. Date: Jun. 5, 2014

(54) SYSTEM FOR QUANTITATIVE CHEMICAL ANALYSIS OF SAMPLES, IN PARTICULAR IN THE MEDICAL FIELD, WITH CALIBRATION OF THE INSTRUMENTAL RESPONSE, AND THE CORRESPONDING METHOD

(71) Applicants: Matteo Floridia, Bareggio (MI) (IT); Simone Cristoni, Vanzago (MI) (IT)

(72) Inventors: Matteo Floridia, Bareggio (MI) (IT); Simone Cristoni, Vanzago (MI) (IT)

(21) Appl. No.: 14/008,726

(22) PCT Filed: Mar. 29, 2012
(86) PCT No.: PCT/IB12/51522

§ 371 Date: Oct. 29, 2013

(30) Foreign Application Priority Data
Mar. 31, 2011 (IT) MI2011A000535

(51) Int. Cl. G06F 19/00

(52) U.S. Cl. CPC G06F 19/366
USPC 702/23

(57) ABSTRACT

Analysis system for the quantitative chemical analysis of samples includes a detection equipment to detect the quantity of target analytes in the samples to be analyzed, which includes a chromatography system, an ion source and a mass spectrometer; a data processing system to process quantitative data of the target analytes in the samples analyzed, as detected by the detection equipment; and an innovative database containing corrective and control data and coefficients to calibrate and correct the instrumental response of the detection equipment, wherein the corrective and control data and coefficients are determined and acquired by the database before the actual analysis of the samples, the sample being prepared with a universal dilution solution to minimize the corresponding matrix effect, the data processing system determining the quantitative data of the target analytes by processing the quantitative data taking account of the corrective and control data and coefficients contained in the database.

### CROSS REFERENCE TO RELATED APPLICATIONS

The present application is the US national stage of International Application PCT/IB2012/051522 filed on Mar. 29, 2012 which, in turn, claims priority to Italian Application MI2011A000535 filed on Mar. 31, 2011.

### FIELD OF INVENTION

The present invention relates in general to the field of systems and equipment for quantitative chemical analysis of samples, typically but not solely in the medical field, and more particularly relates to an analysis system for the quantitative chemical analysis of samples which is characterised by a new and advantageous calibration system designed to calibrate the instrumental response of the specific instrumentation or equipment used in the analysis system to detect the quantity of target analytes present in the various samples analysed.

The invention also relates to a corresponding method for the quantitative analysis of samples, in particular in the medical field, with calibration of the instrumental response of the specific instrumentation or apparatus used to detect the quantitative data of the target analytes present in the various samples analysed.

### BACKGROUND TO THE INVENTION AND PRIOR ART

Modern analytical chemistry, in its practical application, requires increasingly intensive quantitative analysis of organic and inorganic substances and compounds.

In this context, the prior art, as it appears from the technical and scientific literature and the patent information concerning the specific sector of quantitative analytical chemistry, offers a wide variety of systems, processes and solutions, based on different technologies and the use of different types of instruments and equipment, for the quantitative analysis of organic and inorganic substances, molecules and compounds of various kinds and types present in the samples to be analysed.

The following publications are cited by way of example:
Cristoni S. et al. Mass Spectrom Rev. 2003 November-December; 22(6): 369-406;
Mass Spectrom Rev. 2007 September-October;26(5):645-56.

However, independently of the specific instrumentation and equipment actually used to detect the quantitative data, namely the quantity of target analytes present in the sample or the various samples analysed, the different processes and systems currently known for conducting these quantitative analyses have some common stages, characteristics and elements.

In particular, an essential operation, which in practice is present in and shared by all known systems and processes for quantitative analysis of the analytes present in a sample, consists of preliminary calibration of the instrumental response of the instrumentation and equipment actually used to detect the quantity of analytes in the samples analysed.

Another common denominator of the currently known quantitative chemical analysis systems is that said preliminary instrumental calibration is usually performed with known target compounds or commercial analysis standards, available on the market, consisting of substances and/or compounds that reproduce and contain, in known concentrations and compositions, the target analytes present in the sample to be quantitatively analysed.

Such calibration is necessary in practice because the instrumental responses of the equipment and instrumentation used in said quantitative analyses can vary from machine to machine, even when the machines are the same brand and model, made by the same manufacturer.

In other words it is advisable, and often necessary, to standardise and calibrate the response of the specific instrumentation used with the aid of said commercial analysis standards, in order to obtain quantitative data relating to the analytes in the sample which is as precise and reliable as possible.

This calibration can be performed in various ways and systems and is designed, according to the usual terminology in this field, to “calibrate” the instrumental response of the instrumentation which will be used for quantitative analysis of the sample.

For example, the calibration system, after detecting in said commercial analysis standards, using specific detection instrumentation, a set of quantitative data relating to the analyte contained in the commercial standard, constructs a calibration curve from those data, creating a graph with the known concentration values of the analyte on the x-axis, and the intensity values of the corresponding signal emitted by the detection instrumentation on the y-axis.

In particular, the field of variation of the concentration of the analyte present in said target standards or compounds used at this stage of calibration is selected so that there is a linear ratio between the intensity of the response signal of the instrumentation and the concentration of said analyte.

Consequently, the exact quantity of the target analyte or analytes of unknown concentration contained in the reference sample or matrix is determined by analysing the sample with the instrumentation and extrapolating the concentration values of the analyte present in the sample from the intensity values of the corresponding signal emitted by the instrumentation, using the calibration line previously constructed, which correlates the two quantities.

More precisely, different methods and variations have been developed, which can be summarised in the following two categories A and B, for the instrumental calibration of the response of the specific instrumentation used to detect the quantity of analytes present in the sample.

A. Successive Addition Method

This method involves direct analysis of a sample Y, which typically consists of a solution containing target compound or analyte X of unknown concentration [x], and is divided into the following stages.

First, the analyser detects a signal of intensity Iₓ for analyte X, which is plotted on the y-axis of a CS (Concentration vs. Signal) graph, and conventionally paired, on the x-axis, with a concentration value [x] of analyte X amounting to zero, namely [x]=0.

Next, in order to obtain the quantitative analysis of the initial solution Y, known and increasing quantities of a commercial standard of analyte X are added to it, and a specific analysis is performed on each addition, the intensity of the corresponding signal being detected.

The various values of the concentrations of the additions and the intensity values of the corresponding signals resulting from the analysis are then reported on the CS graph.

At this point a check is made, by observing the resulting graph, to ensure that the response of the analyser is linear; if it is, a linear interpolation is performed of the points indicated on the graph in order to obtain the concentration of target analyte X in sample Y from the point of intersection of the line thus obtained with the x-axis.

The main drawback of this first method and approach is the high error of the quantitative data obtained, which makes this method inadvisable in many fields of analysis, such as clinical diagnostic analysis, forensic analysis, and quantitative analysis of medicaments, pesticides and other compounds.

B. Isotope Dilution Method

This method is mainly used in the field of quantitative analysis using mass spectrometry, and is divided into the following stages.

First, a commercial compound or standard is added to the sample solution to be analysed which has the same formula as the target compound or analyte, but wherein some elements are replaced by the corresponding non-radioactive isotopes, or by elements characterised by the same atomic number Z but a different mass number A (the most common substitution being the exchange of hydrogen atoms ¹H with deuterium atoms ²H).

The molecular weight of the standard compound is varied in this way.

The quantity of standard compound added to the sample solution is also established so that its concentration in said sample solution is certainly greater than that of the target analyte.

For this purpose, the ratio between the intensities of the two signals is evaluated, bearing in mind that the compounds substituted supply the same instrumental response as those without isotopic markers, so the only difference between them is the mass/charge ratio m/z.

Two co-eluted peaks, of the standard and the target analyte respectively, are therefore obtained, the second peak being certainly lower than the first in terms of amplitude.

Next, by calculating the ratio between the two areas defined by said two peaks, a concentration factor is obtained, from which the sample solution is diluted until the signal of the target analyte is equal to that of the standard compound replaced.

The occurrence of this circumstance, which indicates parity of concentrations between the analyte and the corresponding standard, will be demonstrated by the appearance of two identical peaks.

At this point the dilution factor used to equalise the two peaks, multiplied by the known concentration of the standard, supplies the real concentration of the target compound or analyte in the sample solution.

The main drawback of this second method and approach is that it requires the use of extremely expensive isotopic standards, which limit the actual use of said method to centres that regularly process large amounts of samples, such as hospitals, forensic analysis centres, and quality control and similar laboratories.

For the sake of clarity, FIG. 5 schematically summarises the current situation, as presented above, namely the operations and numerous manual steps currently required by the prior art, which an operator must perform to prepare the sample for quantitative analysis, calibrate the specific instrumentation which will be used to conduct the analysis before analysing each sample, and finally, conduct the actual analysis of the sample with the instrumentation, when calibrated, to obtain the quantitative data of the sample analysed.

A sample Y, containing a target analyte [x], is suitably diluted, at a preliminary stage F1, in a sample solution Y1 suitable to be quantitatively analysed.

Again at a preliminary stage, the instrumentation, in particular comprising a mass spectrometer, which will be used for the quantitative analysis of sample solution Y1, is calibrated with commercial or industrial standards SI[x] specific for the target analyte[x], as schematically illustrated by a calibration stage F2.

Next, as schematically illustrated by a stage F3, sample solution Y1 is analysed with the analysis instrumentation, namely the mass spectrometer, after calibration, which thus provides the operator with the analysis results, namely the quantitative data of the target analyte [x] present in the sample analysed Y, as schematically illustrated by a final stage F4.

In some cases standard SI[x] can be added to sample solution Y1 to perform an “in-matrix” calibration, as schematically illustrated by a stage F2′.

It is important to note that the calibration of the instrumentation used for the analysis must be repeated every time; in other words, it must be performed before the analysis of each sample, which, as already stated, constitutes a considerable drawback of the prior art.

### SUMMARY OF THE INVENTION

A primary purpose of the present invention is therefore to offer and implement an analysis system for quantitative analysis of samples, typically but not solely in the medical field, which represents a considerable innovation on the analysis systems currently known and applied, and in particular, unlike known systems, does not require during analysis of the samples and before each analysis the continuous use of commercial analysis standards to calibrate the response of the instrumentation used in the analysis system to detect the quantity of target analytes present in the various samples to be analysed.

Said purpose can be deemed to be fully achieved by the system for quantitative chemical analysis of samples and the corresponding method which have the characteristics defined by independent claims 1 and 9 respectively.

Particular embodiments of the present invention are also described in the dependent claims.

As will clearly appear from the rest of the description, the basic concepts and guidelines which guided the development of the sample analysis system according to the present invention, and therefore form the basis thereof, can be summarised as follows.

1) Initial preparation of a universal matrix or sample solution, namely a matrix obtained by diluting the original sample to be analysed in a universal dilution solution, in order to standardise the chemico-physical characteristics of the matrix and make them reproducible over time so as to maximise, standardise and make reproducible over time the instrumental response of the machine, instrumentation or equipment used to detect the quantitative data of the analytes present in the samples analysed.

2) Preliminary acquisition of instrumental data for each analyte and matrix, using commercial analysis standards, to obtain the specific response factors which connect the various parts of the system consisting of analyte, matrix and machine for quantitative detection of the analyte.

3) Creation of a special database, containing in particular calibration data and parameters destined to be used, during the analysis of multiple samples, to process the data acquired by the analysis system and precisely calibrate the signal, namely the instrumental response of the specific detection equipment used to detect the target analytes in the samples analysed, so that there is no longer any need for continuous, expensive use of commercial standards to calibrate the detection equipment.

In this respect, it should be noted that there is no equipment or system for the quantitative chemical analysis of samples in the prior art that interfaces with a database to extract data from it which is useful for the purpose of absolute molecular quantitation of the analyte or analytes present in the samples to be analysed, so that there is no need to calibrate the instrumentation for the quantitative detection of said analyte or analytes every time, before the analysis of each sample.

The main innovation characterising the present invention is therefore the availability and use of such a special database, and the use of an ion source such as USIS or SACI in combination with a conventional mass spectrometer, as more particularly described below.

The use of these two ion sources is crucial, because it maximises the sensitivity of mass spectrometers, increasing the quantitative accuracy of the analysis, since the greater the analytical sensitivity, the more stable the signal, and consequently the quality and precision of the quantitative data obtained, will be.

The analysis system according to the invention also includes, as an essential part and a further innovation, a control system designed to monitor some parameters constantly during analysis, checking their conformity, said parameters being indicative of the “matrix effect”, namely the effect in the sample analysed deriving from its original matrix or molecular composition, and of the variation in the instrumental response of the instrumentation or equipment used to detect the quantity of the analytes in the samples analysed.

More specifically, the different variables monitored in the analysis system according to the invention are processed so as to determine two coefficients which are stored in the database, namely:

a) a monitoring coefficient K which can be used as reference for monitoring the stability and variability over time of the instrumental signal generated by the instrumentation for quantitative detection of analytes; and

b) an evaluation coefficient K1 which can be used as reference to evaluate, in the sample analysed, the corresponding matrix effect deriving from its original matrix or molecular composition.

As more particularly explained below, said coefficient K1 is indicative of the variation in the slope of the line obtained by analysing increasing volumes of the sample and plotting on a graph the corresponding signals generated by the target analyte present in the sample analysed.

### ADVANTAGES OF THE INVENTION

The system for quantitative analysis of chemical substances and compounds present in samples to be analysed, in accordance with the present invention, will be identified, in particular commercially, by the acronym PROSAD (derived from the term PROgressive Sample Dosage), and possesses numerous significant advantages, some of which were announced in the introduction above, compared with the analysis systems for quantitative chemical analysis of samples currently known and applied, in particular in the medical field.

Some of these advantages, corresponding to the various aspects of the analysis system according to the invention, will be briefly presented below, by way of example but not of limitation, and compared with the analysis systems currently known and used.

Firstly, the analysis system according to the invention is particularly advantageous as regards the calibration system it uses to calibrate the detection instrumentation used to detect the quantity of target analytes in the various samples to be analysed, in particular in the medical field and when said detection instrumentation is a mass spectrometer.

As partly already stated, a common denominator of all the current analysis methods that employ mass spectrometry is the use of commercial analysis standards before every single analysis, ie. before the analysis of a particular analyte or category of analytes present in the sample, to calibrate the instrumental response of the mass spectrometer.

The present invention, namely PROSAD, was developed to allow standardisation of the instrumental responses of the mass spectrometer, ie. to make them precise, reliable and reproducible over time, without having to continually use said commercial analysis standards in the performance of the quantitative analyses of the various samples, and when the type of target analyte present in them varies.

To sum up, PROSAD provides the following four advantages.

Financial Advantage

The first advantage is financial, because with the PROSAD system, commercial standards are no longer used for each analysis, only at the initial stage of acquisition of the data required to create and structure a suitable database, leading to a considerable saving in the cost of the standards.

Structural Advantage

The structural advantage derives from the fact that, as already stated, each commercial standard corresponds to one target molecule only, thus limiting the possibility of analysis to a single molecule.

However, the PROSAD system, by standardising the instrumental response of many analytes, makes it possible to conduct both qualitative and quantitative analysis of multiple target molecules simultaneously.

PROSAD also meets the need to simplify analysis procedures for the preparation of samples, which at present usually require the development, for each compound, of a specific preparation and the corresponding analysis methods whenever a new analyte, or the same analyte present in different matrices, is to be monitored.

Time Advantage

The time saving offered by PROSAD is obvious, and consists of the sum of three factors.

There is a first time saving in the development and validation of specific methodologies whenever a new analyte is analysed, a second saving in the preparation of each sample, and a third saving of the machine time required to analyse numerous target molecules for each sample.

With PROSAD, a single, shorter, considerably simplified methodology is used to prepare the samples to be analysed, and it is also possible, as stated, to analyse a number of target substances simultaneously.

Qualitative Advantage

The qualitative advantage, which constitutes another considerable benefit, derives from the greater accuracy of the quantitative data obtained with PROSAD.

By limiting the steps and manual operations performed by the laboratory technician, and the number of analyses per sample, PROSAD eliminates a substantial proportion of measurement and instrumental error affecting the final data, which will therefore be more precise.

Moreover, the special configuration and type of the equipment used by PROSAD, which in particular includes ion sources able to maximise the sensitivity of the mass spectrometer, further help to increase the quality and accuracy of the analysis data obtained.

Finally, a further advantageous contribution is given by the high precision of the data processing system included in PROSAD.

In this respect, numerous tests demonstrate that the data obtained with PROSAD are 10% more precise on average than those obtained with conventional analysis methodologies.

### BRIEF DESCRIPTION OF DRAWINGS

These and other purposes, characteristics and advantages of the system for quantitative analysis of samples according to the present invention will appear more clearly from the following description of a preferred embodiment thereof, given by way of example but not of limitation, with reference to the annexed drawings, wherein:

FIG. 1 is a functional block diagram which extremely concisely represents the essential parts of an analysis system according to the present invention for the quantitative chemical analysis of samples, preferably but not exclusively in the medical field;

FIG. 2 is a functional block diagram which represents in greater detail the various parts of the sample analysis system shown in FIG. 1;

FIG. 3 is a more detailed block diagram of the part of the analysis system shown in FIG. 1 which specifically relates to the preparation of samples to be analysed;

FIG. 4 is a flow chart which illustrates the operation of instrumental calibration of the specific detection equipment used in the analysis system according to the invention shown in FIGS. 1 and 2 to quantitatively detect the target analytes present in the samples analysed; and

FIG. 5 is a block diagram of an analysis system and the corresponding instrumental calibration system of the analysis instrumentation used, according to the prior art.

### DESCRIPTION OF A PREFERRED EMBODIMENT OF THE INVENTION

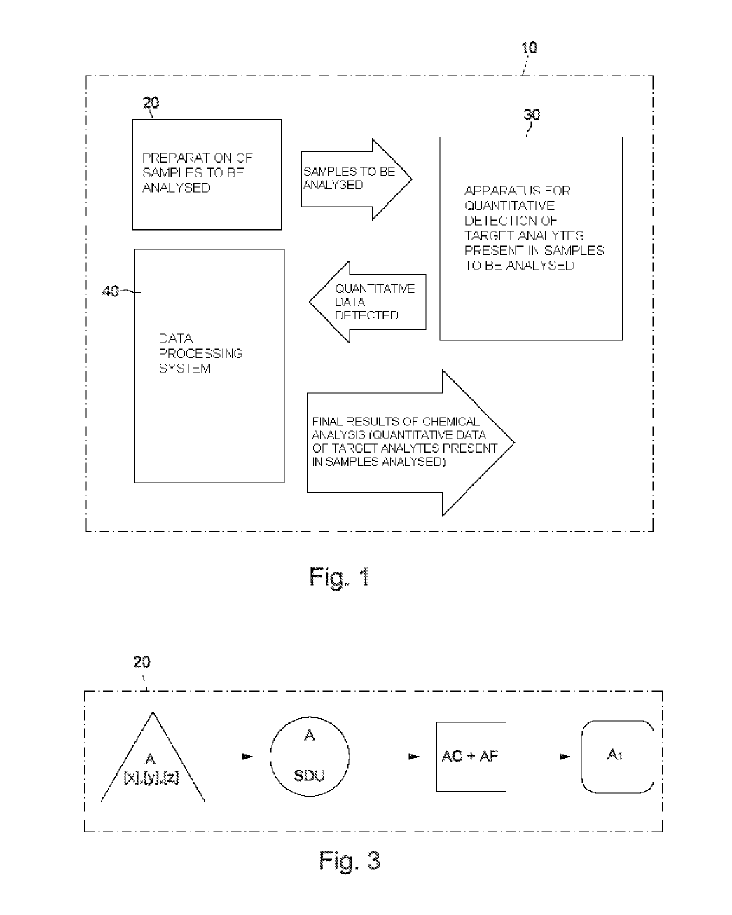

FIG. 1 shows, in an extremely schematic form, an analysis system according to the present invention indicated as 10, for the quantitative chemical analysis of samples, which is also called “PROSAD”, the acronym for PROgressive Sample Dosage, as already stated.

Said analysis system 10 will preferably, though not exclusively, be used in the medical field, for example to conduct quantitative chemical analysis of target analytes contained in biological matrices, as more particularly specified below, with specific examples of application relating to human urine or plasma samples.

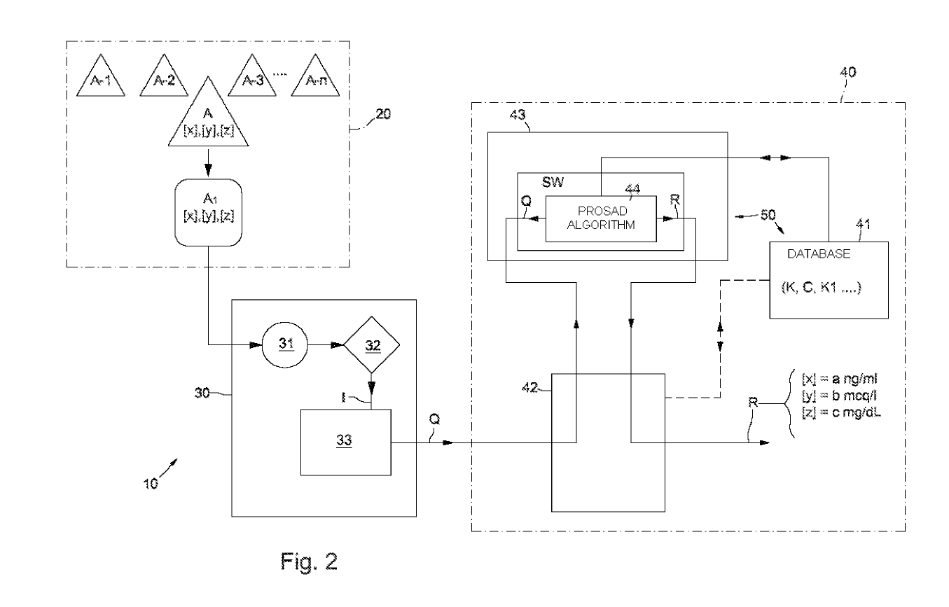

Analysis system 10 according to the invention, as a whole (FIG. 2), namely PROSAD, substantially consists of the following three basic parts, which mutually interact and cooperate, namely:
a first part, schematically illustrated as block 20, which corresponds to a preliminary stage of preparation of the sample or samples destined to be quantitatively analysed with analysis system 10;
a second part, schematically illustrated as block 30, which corresponds to specific dedicated detection equipment, hereafter called “the detection equipment”, which is designed, in the ambit of analysis system 10, to detect, during a detection stage, the quantity of the target analyte or analytes present in the sample(s) analysed; and
a third part, schematically illustrated as block 40, which corresponds to a data processing system having the function of processing, during a processing stage, quantitative data Q detected by dedicated equipment 30 to determine the final results R of the analysis, namely the quantitative data of the target analytes present in the sample(s) analysed.

As explained in greater detail below, data processing system 40 is also associated with an innovative calibration system, generally indicated as 50, of the instrumental response of dedicated detection equipment 30.

Said three parts 20, 30 and 40 of analysis system 10 will now be described in detail.

Preliminary Stage of Preparation of Sample to be Analysed

The first part 20 which, as stated, corresponds to a preliminary sample preparation stage, comprises some specific operations performed on an original sample to be analysed, indicated as A and schematically illustrated in FIG. 2, to normalise the matrix effect deriving from its specific molecular composition.

Preparing the sample to be analysed so as to reduce the final matrix effect to a standardisable, reproducible value is essential to ensure that the analysis data obtained are valid, as the matrix effect is a well-known phenomenon which can cause considerable problems and critical factors in the quantitative characterisation of the sample (see the publication Cristoni S. et al. Rapid Commun Mass Spectrom. 2006; 20(16): 2376-82).

For example, it has been found that if the matrix effect in the sample analysed is high, the analysis error can reach levels exceeding 50% of the real value of the target data (see Cristoni S. et al. Rapid Commun Mass Spectrom. 2006; 20(16): 2376-82).

In detail, by reference to the diagram in FIG. 3, the procedure followed at this stage of sample preparation is as follows.

a) First, universal dilution solution UDS, which is standard and applicable to any complex matrix, is prepared by diluting, for example in 900 microlitres of a 100 millimolar ammonium bicarbonate solution (NH₄HCO₃, 100 mM), 100 microlitres of a solution containing 1000 ppm of caffeine, 1000 ppm of testosterone and 1000 ppm of progesterone, which constitute the three internal calibrants of the chemical system, thus obtaining a final volume of 1 millilitre.

b) Universal dilution solution UDS is then reconstituted with freeze-dried plasma, in suitable proportions, to obtain a final solution stabilised to pH=8.

c) At this point, the original sample A, containing the target analytes, such as [x], [y] and [z], is diluted in a 1:1 ratio in universal dilution solution UDS, which is standard and applicable to any complex matrix.

The matrix effect is then normalised.

d) For this purpose, a dilution solution is prepared by adding one part formic acid FA to 99 parts pure acetonitrile AC (99%+1%);

e) Part of the solution containing the plasma is then diluted in nine parts of the acetonitrile-based solution (dilution ratio 1:10), so that the high molecular weight protein contained in the plasma+sample solution instantly precipitates.

f) The solution thus obtained is centrifuged, for example at 13,000 rpm for 1 minute, after which 200 microlitres, for example, of supernatant is taken up, which constitutes sample solution A₁ destined to be analysed with specific detection equipment 30.

The primary objective of this preparatory procedure, designed to constitute a standard or normalised analysis matrix, is to standardise and normalise the chemico-physical properties of the solution to be analysed, so as to prevent singular, specific matrix effects due to the specific composition of original samples of different kinds.

Such normalisation is made possible by the characteristics of the solution, which is prepared at this preparation stage 20 by buffering the pH to a value close to neutrality (pH=8), so as not to favour either the protonation or the deprotonation of the target analytes, and by creating, with freeze-dried plasma, a complex chemico-physical environment having a matrix effect able to mask that of the original sample, so as to produce a single reproducible, predictable matrix effect for the next stage of processing, by system 40, of the data detected by equipment 30.

As an alternative to the precipitation process described in paragraphs “d” and “e” above, preparation involving the use of molecular cut-off filters can be performed.

In this case, the alternative process involves the following stages.

a) First, universal dilution solution UDS, which is standard and applicable to any complex matrix, is prepared by diluting, for example in 900 microlitres of a 100 millimolar ammonium bicarbonate solution (NH₄HCO₃, 100 mM), 100 microlitres of a solution containing 1000 ppm of caffeine, 1000 ppm of testosterone and 1000 ppm of progesterone, which constitute the three internal calibrants of the chemical system, thus obtaining a final volume of 1 millilitre.

b) Universal dilution solution UDS is then reconstituted with freeze-dried plasma, in suitable proportions, to obtain a final solution stabilised to pH=8.

c) At this point, the original sample A, containing the target analytes, such as [x], [y] and [z], is diluted in a 1:1 ratio in universal dilution solution UDS, which is standard and applicable to any complex matrix.

The matrix effect is then normalised.

d′) The UDS solution thus obtained is introduced into an Eppendorf test tube with a molecular cut-off filter, which prevents substances with a molecular weight exceeding a pre-set limit (e.g. 3000 Da, 5000 Da or 10,000 Da) from passing through its mesh. This limit is identified on each occasion by reference to the analysis conditions imposed by the matrix analysed and the characteristics of the target analytes.

f) The solution thus obtained is centrifuged, for example at 13,000 rpm for 1 minute, after which 200 microlitres, for example, of supernatant is taken up, which constitutes sample solution A₁ destined to be analysed with specific detection equipment 30.

Dedicated Equipment for Analysis and Quantitative Detection of Sample

The dedicated detection equipment corresponding to part 30 of analysis system 10 according to the invention, namely PROSAD, which is designed to detect the quantities of the target analyte or analytes in the sample analysed, basically consists of a chromatography system 31, through which sample A1 to be analysed is injected into detection equipment 30; an ion source or ionisation source 32 designed to receive sample A1 to be analysed from chromatography system SC and ionise it; and a mass spectrometry analyser or mass spectrometer 33 designed to receive ions I of sample A1 produced by ionisation source 32 and subject them to spectrometry examination to detect the quantity of target analytes present in said sample A1, as indicated in the diagram in FIG. 2.

The quantitative data Q of the target analyte or analytes [x], [y], [z] present in sample A1, as detected by mass spectrometer 33, are then sent to data processing system 40 to be suitably processed in order to provide the final result R of the quantitative chemical analysis, namely the quantitative data of the analyte or analytes present in the sample analysed.

Chromatography system 31 consists of an HPLC pump and a chromatography column, the size of which is selected on each occasion on the basis of the analysis requirements.

During use, chromatography system 31 is set up to rapidly inject given volumes of sample A1 to be analysed into ionisation source 32, in quick succession, to allow rapid performance of the analysis.

As regards ion source 32, the possible configurations in the PROSAD system involve the use of an ion source, based on the SACI technique (Surface Activated Chemical Ionisation, disclosed in international patent no. WO 2004/034011 filed by Cristoni S. et al.) or the USIS technique (Universal Soft Ionisation Source, disclosed in international patent WO 2007/131682 filed by Cristoni).

Finally, mass spectrometry analyser 33 included in detection equipment 30 can be a low-resolution instrument (such as the ion trap, single quadrupole, or triple quadrupole type, etc.; see Cristoni S. et al. Mass Spectrom Rev. 2003 November-December; 22(6):369-406), or a high resolution instrument (such as FTICR (Fourier Transform Ion Cyclotron Resonance), TOM (Time Of Flight), orbitrap, etc.; see Cristoni S. et al. Mass Spectrom Rev. 2003 November-December; 22(6):369-406).

Of the low-resolution ion-trap or triple-quadrupole mass spectrometry analysers, the triple-quadrupole type is usually preferable due to its greater accuracy and precision in quantitative data analysis.

The preferred high-resolution analysers are the orbitrap analyser and the flight-time analyser, and of those two, the flight-time analyser is preferred, as it provides better performance in terms of the precision and accuracy of the quantitative data detected.

The added value and advantages of detection equipment 30 used in analysis system 10 according to the invention are obviously determined by the use of ionisation sources 32 based on the SACI or USIS technique.

In particular the SACI (Surface Activated Chemical Ionisation) technique introduces the following two significant, advantageous modifications over the ion sources mainly used to date for the ionisation of compounds at atmospheric pressure, namely ESI (ElectroSpray Ionisation) and APCI (Atmospheric Pressure Chemical Ionisation).

a) the insertion of a metal surface into the ionisation chamber, which improves the ionisation efficiency of the compounds.

This metal surface polarises the neutral solvent, varying its proton affinity and improving the ionisation efficiency of the analyte by

b) application to said metal surface of a low electrical potential (50 V) which retains the solvent molecules that do not reach the analyser, thus providing a considerable reduction in chemical noise.

The USIS technique exploits the same principle as the SACI source, but also advantageously includes an additional photoelectric effect of electronic emission by a polarised plate through the application of UV radiation.

The emission of said electrons due to the photoelectric effect activates ion-molecule reactions that lead to ionisation of the non-polar or apolar as well as the polar compounds.

In this respect, therefore, a USIS ion source is preferable because it allows the analysis of a larger number of compounds, including apolar compounds, than a SACI source.

However, both types of ion source (SACI and USIS) exhibit a crucial property, useful to ensure the efficiency of the PROSAD system, namely the ability to provide stable quantitative data, as the ionisation of the sample to be analysed always takes place at lower voltages than those used by conventional ion sources (<900 V as against 3000-4000 V), such as ESI and APCI.

This reduces the ionisation yield of the chromatography solvent, co-eluent and carrier of the analyte in the column, with a consequent reduction in instrument noise, as the exposure of the chromatography solvent to high ionising potentials generates the formation of charged clusters of molecules, which increase the chemical instrumental noise on reaching the analyser.

The reduction in background noise achieved with SACI and USIS sources therefore enables a more stable signal to be obtained by reducing instrumental interference, and increases the precision of measurement of the quantitative data.

In general, the configuration of detection equipment 30 and its component parts depends on the specific requirements and types of analysis to be performed.

In any event, whatever the configuration of detection equipment 30 which is chosen and adopted for PROSAD, it must be set and calibrated during a calibration stage in order to obtain correct, reproducible results from the quantitative analyses conducted on the samples, as described in detail below.

System for Processing Quantitative Data Detected by Detection Equipment

Part 40, corresponding to the data processing system of analysis system 10 according to the invention, comprises, as schematically illustrated in FIG. 2:
a local workstation 42 associated with detection equipment 30 to receive the quantitative data Q, detected by said detection equipment 30, of the target analytes present in the samples analysed,
a remote computing unit 43, designed to cooperate with local workstation 42, and
a database 41 associated with remote computing unit 43 and containing one or more corrective and control data and coefficients designed to calibrate and correct the instrumental response of detection equipment 30 used to detect the quantitative data of the target analytes present in the various samples analysed.

Remote computing unit 43 can in turn be part of a larger network of computing resources, such as “cloud computing”, so that it does not adversely affect the performance of local workstation 42.

In detail, remote computing unit 43 comprises a general operating program or software SW which in turn includes a specific calculation program or algorithm 44, specifically developed for PROSAD, which is designed to cooperate with database 41 to determine final analysis results R, namely the quantity of target analytes present in the various samples analysed, as more particularly described below.

Advantageously, data processing system 40 is also able to implement machine-learning or super vector machine algorithms, so as to increase and expand its functions.

In operation, workstation 42 transmits quantitative data Q of target analytes [x], [y], [z] present in the samples analysed, as detected by detection equipment 30, to remote unit 43.

At the same time local workstation 42 sends to remote computing unit 43 a request to activate the quantitation of the target analytes, as set by the operator, which are present in the sample under analysis.

In reply to that request, remote computing unit 43 extracts from database 41 the corrective and control coefficients required for correct quantitation of the analytes, and calculates, with specific PROSAD algorithm 44, taking account of said corrective and control coefficients, final analysis result R, namely the quantitative data of the target analyte present in the sample analysed.

Said result R is then transmitted from remote computing unit 43 to local workstation 42, which displays it in output to an operator, as schematically illustrated in FIG. 2.

Database included in the data processing system, and calibration of instrumental response of detection equipment

As already stated, one of the characteristic features of analysis system 10 according to the invention which differentiates it from known quantitative chemical analysis systems is database 41, included in data processing system 40, and its special content and use for the calibration of the instrumental response of detection equipment 30, standardisation and quantitation of the data processed by data processing system 40, and finally, the final calculation of the quantitative data of the target analytes present in the samples analysed, to be provided as final analysis result R.

In particular, said database 41 contains one or more corrective and control coefficients suitable to calibrate the instrumental response of detection equipment 30, namely to suitably correct the quantitative data of the target analytes present in the various samples analysed which are detected by said detection equipment 30.

The characteristics of said innovative database 41, an essential part of the quantitative chemical analysis system according to the present invention, will appear clearly from the detailed description below, which describes the procedures whereby said database 41 is defined on a preliminary basis and the data and information contained in it are determined and acquired, and the procedures whereby said database 41 and the respective data, once defined, operate and are used in analysis system 10 and the corresponding data processing system 40.

1. Database 41 is initially created and defined during a preliminary stage, which precedes the actual analysis of the samples, by annotating and acquiring specific data and information which is directly linked to the specific model and/or brand of mass spectrometer 33 destined to be used to analyse first sample A, and then other samples, schematically illustrated and indicated as A-1, A-2, A-3, . . . A-n in FIG. 2, in analysis system 10 according to the invention.

2. In particular the operator, using commercial calibration standards (in particular reserpine+two molecules to be selected on each occasion, according to the specific application and the type of analysis to be conducted), performs some preliminary spectra with spectrometer 33, which are thus acquired and stored in database 41 for use in the subsequent evaluation and calibration of the response of spectrometer 33.

The same operations as described in paragraphs 1 and 2 can also be performed to input into database 41 the mass spectra obtained by analysing the commercial standards with different brands and models of spectrometer, so as to create in database 41 a library of data relating to a number of mass spectrometer brands and models.

3. In this way, before analysing the samples in question, the instrumental response of spectrometer 33 is optimised and maximised on the reserpine signal, so that a reproducible spectrum is obtained.

As this stage of optimisation of the instrumental response of spectrometer 33 and its optics is always conducted with the same compound, the signal intensity of the commercial standard and that corresponding to the other mass/charge ratios m/z are always reproducible, concentration being equal.

4. The data obtained in the form of intensity of the mass signals of the standard or calibration molecules are then compared with the corresponding experimental data specific to the brand and model of instrument used, namely the spectrometer, which were previously detected and input into database 41 as reference.

Corrective coefficient K=I₀/I is calculated for this purpose; said coefficient is specific to the brand and model of spectrometer used, and is represented by the ratio between the theoretical signal I₀ relating to the calibrant substances and sampled signal I relating to the brand and model of the specific mass spectrometer used for the analysis.

In particular, signal I is selected from those already available in database 41 and obtained with different spectrometer brands and models, according to the procedure indicated in paragraphs 1 and 2.

Said coefficient K is also acquired and stored in database 41.

Coefficient K, as calculated, is indicative of the similarities of the spectra, and consequently of the instrumental response of the specific detection equipment 30 used for the analyses; in order to be acceptable it must tend towards a unitary value, with a maximum allowable deviation of 10%, namely K=1±0.1.

Ratio K=I₀/I also represents a parameter indicative of the detection system, and is therefore designed to be monitored on each analysis, in order to evaluate the fluctuation of the instrumental response over time in quantitative terms, and suitably correct it when necessary.

The check on the constancy of K and all variations thereof over time therefore constitutes a first checkpoint of the operation of detection equipment 30.

5. The signal intensity values of the target analytes are then sampled, by analysing the corresponding commercial standards at the concentration of 1 ppm each.

6. If the standard of the target molecule shows a signal intensity characterised by a signal-to-noise ratio S/N<100, the analyte is considered not to be analysable with PROSAD.

This parameter is essential to limit the proportion of error intrinsic in mass spectrometry technology, and at the same time to increase the precision and accuracy of the data obtained.

However, if the S/N ratio is >100, the ratio between signal I_{X} of the target analyte and coefficient K, previously calculated and acquired by database 41, is calculated.

7. This gives a corrective coefficient C=V*(I_{X}*K)=V*[I_{X}*(I₀/I, wherein V represents a specific variable of the analyser instrument used, namely spectrometer 33, so that said coefficient C is characteristic of both the analyser machine and the specific target compound or analyte, and is also acquired and stored in database 41.

8. At this point, ie. when coefficient C has been determined and acquired by database 41, the acquisition and detection of the quantitative data of the sample to be analysed can proceed.

As the first step, the matrix effect of the system must be considered, and four rapid analyses of increasing volumes of the sample (e.g. 5, 10, 15 and 20 microlitres) are analysed for this purpose.

9. The signal intensities of the target analytes are then plotted on a graph according to the volume of sample injected into mass spectrometer 33 by chromatography system 31 for quantitative analysis.

10. Linear slope coefficient K1, which represents a characteristic parameter of the system analysed, is then extrapolated.

11. At this point, special algorithm 44, developed for PROSAD, which is included in remote computing unit 43, monitors the analysis in progress and in particular checks that coefficient K1 does not vary.

If this check is passed, ie. if K1 does not vary, and consequently remains constant, the matrix effect will be reproducible for the system selected in the analysis.

12. A further coefficient C1=K1*C=K1*[V*(K*I_{X})] is then obtained, wherein I_{X} is the signal intensity of the target analyte, as specified above.

At this point, if PROSAD algorithm 44 verifies the conformity of K and K1 within a defined experimental tolerance, the concentration value of the target analyte can be calculated proportionally to the value of I_{X}.

In practice, assuming that control coefficients K and K1 fall within the pre-set tolerance range, if Cp is the unknown concentration of the target analyte to be determined and Ip is the known intensity of the signal generated by said unknown concentration, the unknown concentration of the analyte, namely the result of the quantitative analysis of the target analyte present in the sample, is given by Cp=C1*Ip/Ix.

On the basis of the factors described above, it is clear that in the ambit of data processing system 40 and the more general quantitative analysis system 10, database 41 performs the essential function of calibrating the instrumental response of specific detection equipment 30, namely mass spectrometer 33, which is actually used in analysis system 10 to detect the quantitative data of the analyte or analytes present in sample A1.

In other words, the corrective and control data and coefficients which are contained in and define said database 41 are used to determine the actual quantitative data of the target analytes present in the sample analysed to be provided to the operator as the final analysis result, by calibrating and suitably correcting the quantitative data detected by said detection equipment 30.

Advantageously, the coefficients described in paragraphs 1-12 above will be monitored and periodically recalculated after a given interval of time, such as every 10 hours, and then entered in a database, namely database 41.

A neural network system based on an algorithm of known type, such as the one described in the following publication: Braisted J C, Kuntumalla S, Vogel C, Marcotte E M, Rodrigues A R, Wang R, Huang S T, Ferlanti E S, Saeed A I, Fleischmann R D, Peterson S N, Pieper R. “The APEX Quantitative Proteomics Tool: generating protein quantitation estimates from LC-MS/MS proteomics results. BMC Bioinformatics” 2008 December 9; 9:529, will evaluate the deviations of these coefficients over time and possibly apply variations and corrections to the corrective coefficient of the calculation formula on the basis of a further corrective coefficient Cr, in order to keep the quantitative accuracy and precision of the measurement stable over time.

In detail, the value of Cp, relative to the concentration of the target analyte, will be multiplied by the corrective coefficient, further corrected as specified above, to correct said deviations of the value of Cp which can cause an increase over time in the quantitative measurement error in the analysis system according to the present invention.

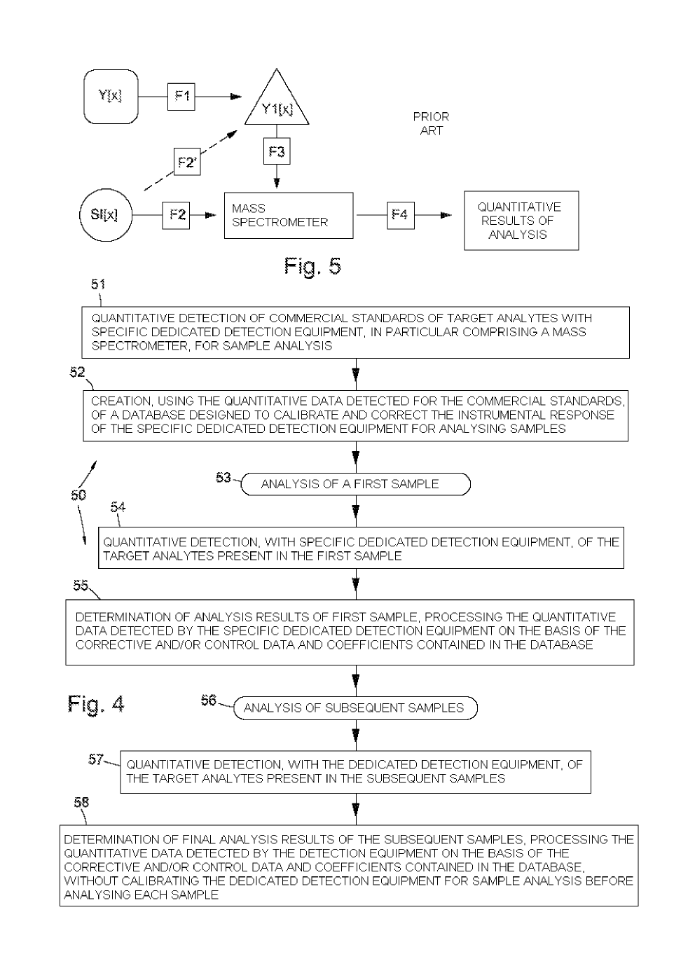

For more complete information and an addition to the preceding description, this calibration system 50, which is an essential part of analysis system 10 according to the invention and performs the function of calibrating the instrumental response of mass spectrometer 33, is represented, in the form of a method or succession of operational stages 51-58, in the flow chart in FIG. 4.

In particular, as will be observed from said flow chart, stages 51 and 52 indicate the preliminary stages during which calibration system 50 quantitatively detects the commercial standards of the target analytes with said specific detection equipment which will be used to quantitate the samples, and uses the quantitative data thus detected to establish on a preliminary basis a database containing corrective and control data and coefficients useful for the instrumental calibration of said specific equipment.

Consequently, stages 53, 54 and 55 relate to the actual quantitative analysis of a first sample, wherein the final results of the analysis of said first sample, namely the quantitative data of the target analytes present in it, are determined by processing and correcting the quantitative data detected in the sample with said specific detection equipment, taking account of the corrective and control data and coefficients contained in the database.

Finally, stages 56, 57 and 58 relate to the analysis of the subsequent samples, schematically illustrated and indicated as A-1, A-2, A-3, . . . A-n in FIG. 2, wherein the quantitative results of said subsequent analyses are obtained by using the corrective and control data and coefficients previously determined and acquired by database 41, and consequently without calibrating before each analysis the equipment, namely the mass spectrometer, which will be used for the quantitative detection of the analytes in the sample, and also without the continuous use of commercial standards of the analytes, as in the prior art, to perform said calibration before each analysis.

Variations and Developments in the Analysis System According to the Invention

Without prejudice to the basic concepts of the present invention, it is obvious that modifications and further improvements could be made to the system for quantitative chemical analysis of samples described so far, while still remaining within the ambit of said invention.

For example, in the ambit of data processing system 40, workstation 42 and database 41 can cooperate directly with one another to exchange data and information, such as corrective data and coefficients K, C, K1 to be used to correct quantitative data Q detected by mass spectrometer 33 and determine the final quantitative data resulting from analysis of the samples, as indicated with a broken line in FIG. 2.

Moreover, although the analysis system according to the invention has been described with specific and preferable reference to a mass spectrometer used in combination with a chromatography system, detection equipment other than a mass spectrometer and the corresponding chromatography system designed to quantitatively detect the analytes present in the samples analysed could be used in the analysis system and therefore be associated with the corresponding novel database, while still remaining within the general concept of the present invention.

Finally, the analysis system according to the invention, while still maintaining its basic concepts and characteristics, could be implemented in various ways, such as being associated with further devices and equipment in order to enhance its performance and improve its results in both quantitative and qualitative terms.

Examples of Application of the Analysis System According to the Invention

Some specific examples of application of analysis system 10 (PROSAD) according to the present invention for the quantitative chemical analysis of samples, in particular in the field of medical analysis, will be described below to supplement the above description.

### Example 1

### Analysis of Cocaine and its Metabolite

In this example, the PROSAD technology was used to quantitate cocaine and its metabolite benzoylecgonine in urine samples.

A binary chromatography gradient was used, consisting of phase A) H2O+0.05% formic acid and phase B) CH3CN+0.05% formic acid. At time t=0 when the injection is given, % B is 15%. This condition is maintained for 2 minutes. After that interval, % B is increased to the value of 70% in 8 minutes. The initial conditions are restored in the next 2 minutes. The instrumental acquisition time was set to 24 minutes. A ThermolEctron C8 150×1 mm chromatography column was used. The surface potential, electrospray potential and surface temperature were 50 V, 0 V and 110° C. respectively. The nebulisation gas flow rate was 2 L/min.

### Example 2

### Analysis of Testosterone in Plasma Samples

The PROSAD system was used to assay the testosterone contained in human plasma.

A binary chromatography gradient was used, consisting of phase A) H2O+0.05% formic acid and phase B) CH3CN+0.05% formic acid. At time t=0 when the injection is given, % B is 15%. This condition is maintained for 2 minutes. After that interval, % B is increased to the value of 70% in 8 minutes. The initial conditions are restored in the next 2 minutes. The instrumental acquisition time was set to 24 minutes. A ThermolEctron C8 150×1 mm chromatography column was used. The surface potential, electrospray potential and surface temperature were 50 V, 0 V and 110° C. The nebulisation gas flow rate was 2 L/min.

### Example 3

### Analysis of Tacrolimus in Whole Blood Samples

In this example, the PROSAD system is used to assay an immunosuppressant called Tacrolimus (anti-rejection drug) contained in human plasma.

A binary chromatography gradient was used, consisting of phase A) H2O+0.05% formic acid and B) CH3CN+0.05% formic acid. At time t=0 when the injection is given, % B is 15%. This condition is maintained for 2 minutes. After that interval, % B is increased to the value of 70% in 8 minutes. The initial conditions are restored in the next 2 minutes. The instrumental acquisition time was set to 24 minutes. A ThermolEctron C8 150×1 mm chromatography column was used. The surface potential, electrospray potential and surface temperature were 50 V, 0 V and 110° C. respectively. The nebulisation gas flow rate was 2 L/min.

Finally, for the sake of completeness, the following table indicates, for each of the application examples described above, the % measurement precision error and the instrumental accuracy error in the measurement of the target analytes using the PROSAD system according to the invention.

In particular, the % instrumental accuracy error was determined by comparison with the data acquired by quantifying the samples with the linear calibration method and using deuterated standards as the compounds added to the samples.

| | | % error relating to the |
|---|---|---|
| | | accuracy of the detection |
| | | instrumentation, namely the |
| Compounds | % precision error | mass spectrometer |
| Cocaine | 6-10 | 8-13 |
| Benzoylecgonine | 6-10 | 6-10 |
| Testosterone | 2-4 | 2-5 |
| Tacrolimus | 11-15 | 13-17 |

1-8. (canceled)

9. An analysis system for the quantitative chemical analysis of samples, comprising:
a specific detection instrumentation or apparatus designed to detect the quantities of the target analytes present in the various samples to be analyzed, said specific detection apparatus in turn comprising a chromatography system, an ion source and a mass spectrometer;
a data processing system designed to receive and process the quantitative data, as detected by said specific detection apparatus, of the target analytes that are present in the samples analyzed, so as to determine from said quantitative data the final quantitative data of the target analytes present in each sample analyzed; and
a database associated with said data processing system and containing data and corrective and/or control coefficients designed to calibrate and correct the instrumental response of said specific detection apparatus,
wherein, in said analysis system, said data processing system is also designed to take into account corrective and/or control coefficients, contained in said database, in the formulas for determining from the quantitative data, as detected by said specific detection apparatus, the final quantitative data of the target analytes present in each sample analyzed,
wherein said data and said corrective and/or control coefficients, contained in said database are determined by detecting by means of said specific detection apparatus the quantitative data of given calibrating substances and commercial standards of the target analytes and acquired by said database at a preliminary stage that precedes the effective quantitative analysis of the samples by the analysis system,
whereby the analysis final quantitative data and results of the samples analyzed are determined by said data processing system, by processing the quantitative data as detected by said specific detection apparatus, while taking into account the corrective and/or control data and coefficients contained in the database and without calibrating the specific detection apparatus before analyzing each sample,
wherein a first of said corrective and/or control coefficients, contained in said database, is defined by the following formula:
K=I₀/I,
where K is said first corrective and/or control coefficient, I₀ is the theoretical signal corresponding to a given calibrating substance, and I is the signal obtained by sampling and quantitatively analyzing said given calibrating substance by means of said specific detection apparatus intended to be used for analyzing the samples,
whereby said first corrective and/or control coefficient K is characteristic of the brand and model of the specific detection apparatus and in particular of the corresponding mass spectrometer used for quantitatively analyzing the samples, and is also suitable for being taken as reference for monitoring the stability over time of the instrumental signal generated by said specific detection apparatus,
wherein a second of said corrective and/or control coefficients, contained in said database, is defined by the following formula:
C=V*(Ix*K), or C=V*[Ix*(I₀/I)],
where C is said second corrective and/or control coefficient, V is an instrumental variable that is dependent on the specific detection apparatus that is used and in particular is distinctive of its instrumental response, and Ix is the signal obtained by detecting, with said detection apparatus, the quantitative data of commercial standards of the target analytes to be quantified in the samples,
whereby said second corrective and/or control coefficient C is characteristic both of said specific detection apparatus, used to analyze the samples, and of the specific target analytes to be quantified in the samples analyzed, and
wherein the final quantitative data or result of the quantitative analysis of the target analytes present in the sample analyzed is determined by the data processing system with the following formula:
Cp=C1*Ip/Ix,
where Cp corresponds to the unknown concentration, to be determined, of the target analyte, Ip is the known intensity of the signal generated by said unknown concentration Cp, and C1 is a further coefficient defined by the following formula:
C1=K1*C=K1*[V*(K*Ix)],
implying Cp=K1*V*K*Ip,
where K1 is a further third control coefficient which is suitable for evaluating the matrix effect in the analyzed sample and is indicative of the slope of the line obtained by analyzing increasing volumes of the sample and plotting on a graph the corresponding signals generated by the target analyte present in the sample analyzed,
wherein said unknown concentration Cp is determined by the data processing system after verifying that the control coefficients K and K1 fall within a pre-established range of tolerance, and
wherein the samples to be analyzed are prepared in an initial preparatory phase by diluting the original samples in a suitable universal dilution solution capable of minimizing the matrix effect by standardizing the chemical-physical characteristics of the matrix, so as also to standardize and make reproducible over time the instrumental response of the specific detection apparatus used to detect the quantitative data of the analytes present in the samples analyzed.

10. The analysis system according to claim 9, wherein the respective data processing system in turn comprises:
a local workstation directly connected to said specific detection apparatus to receive the quantitative data, as detected by the latter, of the target analytes present in the samples analyzed, and
a remote computing unit containing a specific computing program,
wherein said workstation transmits to said remote computing unit the quantitative data, as detected by said specific detection apparatus, of the target analytes present in the samples analyzed,
wherein said specific computing program, associated with said remote computing unit determines, from the quantitative data, detected by said specific detection apparatus and while taking into account the corrective data contained in said database, the results of the analyses carried out on the samples, namely the quantitative data of the target analytes present in the samples analyzed, and
wherein said local workstation receives from said remote computing unit and displays to an operator said results, as determined by said specific computing program, indicating the quantities of the target analytes present in the samples analyzed.

11. The analysis system according to claim 9, wherein said data processing system is also able to implement given machine-learning algorithms designed to increase and expand the functions of said data processing system.

12. The analysis system according to claim 9, wherein said universal dilution solution is prepared by diluting, for example in 900 microliters of a 100 millimolar ammonium bicarbonate solution, 100 microliters of a solution containing 1000 ppm of caffeine, 1000 ppm of testosterone and 1000 ppm of progesterone, which constitute the three internal calibrants of the chemical system, thus obtaining a final volume of 1 milliliter.

13. The analysis system according to claim 12, wherein said universal dilution solution is then reconstituted with freeze-dried plasma, in suitable proportions, to obtain a final solution stabilized to pH=8;
wherein the original sample containing the target analytes is then diluted in a 1:1 ratio in said universal dilution solution,
wherein, in order to normalize the matrix effect, a dilution solution is prepared by adding one part of formic acid to 99 parts of pure acetonitrile, and then one part of the solution containing the plasma is diluted in nine parts of the acetonitrile-based solution, that is in a 1:10 dilution ratio, so that the proteins of high molecular weight contained in this solution containing the plasma and the original sample instantly precipitate, and
wherein the solution thus obtained is then centrifuged, after which a given quantity of it is taken up, constituting the sample destined to be quantitatively analyzed and detected with said specific detection apparatus.

14. A method for the quantitative chemical analysis of samples, comprising the following stages:
providing a specific detection instrumentation or apparatus to be used for quantitatively detecting the target analytes present in the samples that will be analyzed, said specific detection apparatus comprising a chromatography system, an ion source and a mass spectrometer;
preliminarily defining, before the actual quantitative analysis of the samples, a database containing data and corrective and/or control coefficients to be used for calibrating the instrumental response of said specific detection apparatus,
said data and said control coefficients being determined by detecting by means of said specific detection apparatus the quantitative data of given calibrating substances and commercial standards of the target analytes; and
determining the results of the analyses of the samples, namely the final quantitative data of the target analytes present in each sample analyzed, by processing, while taking into account said data and corrective and/or control coefficients contained in said database, the quantitative data, as detected by said specific detection apparatus, of the target analytes in the sample analyzed;
whereby the analysis final quantitative data and results of the samples are determined without calibrating the specific detection apparatus before analyzing each sample,
wherein the stage of preliminarily defining said database comprises the stage of:
acquisition by said database of a first corrective and/or control coefficient defined by the following formula:
K=I₀/I,
where K is said first corrective and/or control coefficient, I₀ is the theoretical signal corresponding to given calibrating substances, and I is the signal that is obtained by sampling and quantitatively analyzing said calibrating substances by means of said specific detection apparatus intended to be used for analyzing samples,
whereby said first corrective and/or control coefficient K, acquired by said database, is characteristic of the type and model of said specific detection apparatus used for analyzing the samples,
and also comprises the stage of:
acquisition by said database of a second corrective and/or control coefficient defined by the following formula:
C=V*(Ix*K), or C=V*[Ix*(I₀/I)],
where C is said second corrective and/or control coefficient, V is an instrumental variable that is dependent on the specific detection apparatus that is used and in particular is distinctive of its instrumental response, and Ix is the signal that is obtained by detecting, with said detection apparatus, the quantitative data of commercial standards of the target analytes to be quantified in the samples,
whereby said second corrective and/or control coefficient C, acquired by said database, is characteristic both of the specific detection apparatus used for analyzing the samples, and of the specific target analytes to be quantified in the samples analyzed,
wherein, in said stage of determining the results of the analyses of the samples, the final quantitative data or results of the quantitative analysis of the target analytes present in the sample analyzed is determined by the data processing system with the following formula:
Cp=C1*Ip/Ix,
where Cp corresponds to the unknown concentration, to be determined, of the target analyte, Ip is the known intensity of the signal generated by said unknown concentration Cp, and C1 is a further coefficient defined by the following formula:
C1=K1*C=K1*[V*(K*Ix)],
implying Cp=K1*V*K*Ip,
where K1 is a further third control coefficient which is suitable for evaluating the matrix effect in the analyzed sample, and
wherein the method also includes the stage of:
preparing the samples to be quantitatively analyzed by diluting the original samples in a suitable universal dilution solution in order to minimize the corresponding matrix effect.

15. The method according to claim 14, wherein said universal dilution solution is prepared by diluting, for example in 900 microliters of a 100 millimolar ammonium bicarbonate solution, 100 microliters of a solution containing 1000 ppm of caffeine, 1000 ppm of testosterone and 1000 ppm of progesterone, which constitute the three internal calibrants of the chemical system, thus obtaining a final volume of 1 milliliter.

16. The method according to claim 15, wherein said universal dilution solution is then reconstituted with freeze-dried plasma, in suitable proportions, to obtain a final solution stabilized to pH=8;
wherein the original sample containing the target analytes is then diluted in a 1:1 ratio in said universal dilution solution,
wherein, in order to normalize the matrix effect, a dilution solution is prepared by adding one part of formic acid to 99 parts of pure acetonitrile, and then one part of the solution containing the plasma is diluted in nine parts of the acetonitrile-based solution, that is in a 1:10 dilution ratio, so that the proteins of high molecular weight contained in this solution containing the plasma and the original sample instantly precipitate, and
wherein the solution thus obtained is then centrifuged, after which a given quantity of it is taken up, constituting the sample destined to be quantitatively analyzed and detected with said specific detection apparatus.
